(19) United States
(12) Patent Application Publication
(10) Pub. No.: US 2004/0165871 A1
(43) Pub. Date: Aug. 26, 2004

(54) WAFER HOLDER FOR SEMICONDUCTOR MANUFACTURING DEVICE AND SEMICONDUCTOR MANUFACTURING DEVICE IN WHICH THE HOLDER IS INSTALLED

(75) Inventors: Masuhiro Natsuhara, Itami-shi (JP); Hirohiko Nakata, Itami-shi (JP); Manabu Hashikura, Itami-shi (JP)

Correspondence Address: JUDGE PATENT FIRM, RIVIERE SHUKUGAWA 3RD FL., 3-1 WAKAMATSU-CHO, NISHINOMIYA-SHI, HYOGO, 662-0035, JP

(73) Assignee: SUMITOMO ELECTRIC INDUSTIRES, LTD., Osaka-shi (JP)

(21) Appl. No.: 10/708,224

(22) Filed: Feb. 18, 2004

(30) Foreign Application Priority Data
Feb. 21, 2003 (JP) JP-2003-043425

(51) Int. Cl. F27D 11/00; F27B 5/14

(52) U.S. Cl. 392/418; 219/390

(57) ABSTRACT

Affords for semiconductor manufacturing devices a wafer holder and a semiconductor manufacturing device in which it is installed, where in the wafer holder, which has a wafer-carrying side, the isothermal quality of its wafer-carrying side is enhanced. A shaft that supports the wafer holder having a wafer-carrying side is joined to the wafer holder, wherein by making a distance a between the center axis of the shaft and the axial center of the wafer-carrying side 5% or less of the diameter L of the wafer-carrying side, the temperature distribution in the surface of a wafer set into place on the holder can be brought to within ±1.0%. Moreover, making the distance a 1% or less of the diameter L enables the temperature distribution to be brought to within ±0.5%.

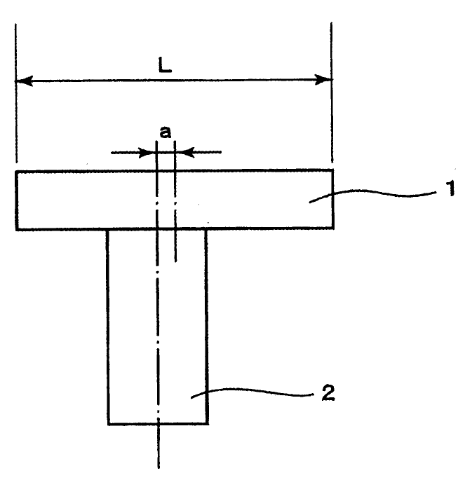

### BACKGROUND OF INVENTION

1. Field of the Invention

The present invention relates to wafer holders employed in semiconductor manufacturing devices such as plasma-assisted CVD, low-pressure CVD, metal CVD, dielectric-film CVD, ion-implantation, etching, low-k film heat-treatment, and degassing heat-treatment devices, and furthermore to process chambers and semiconductor manufacturing devices in which the wafer holders are installed.

2. Description of the Background Art

Conventionally, in semiconductor manufacturing procedures various processes such as film deposition processes and etching processes are carried out on semiconductor substrates that are the processed objects. Ceramic susceptors, which are both for retaining semiconductor substrates and for heating semiconductor substrates, are used in the processing devices in which such processes on semiconductor substrates are carried out.

Japanese Unexamined Pat. App. Pub. No. H04-78138 for example discloses a conventional ceramic susceptor of this sort. The ceramic susceptor disclosed in H04-78138 includes: a heater part made of ceramic, into which a resistive heating element is embedded and that is provided with a wafer-heating surface, arranged within a chamber; a columnar support part that is provided on the side other than the wafer-heating side of the heater part, and that forms a gastight seal between it and the chamber; and electrodes connected to the resistive heating element and leading outside the chamber so as essentially not to be exposed to the chamber interior space.

Although this invention serves to remedy the contamination and poor thermal efficiency that had been seen with the metal heaters that had gone earlier, it does not touch upon temperature distribution in semiconductor substrates being processed. Nonetheless, semiconductor-sub-strate temperature distribution is crucial in that it proves to be intimately related to yield in the situations where the various processes just noted are carried out. Given the importance of temperature distribution, Japanese Unexamined Pat. App. Pub. No. 2001-118664, for example, discloses a ceramic susceptor capable of equalizing the temperature of its ceramic substrate. In terms of this invention, it is tolerable in practice that the temperature differential between the highest and lowest temperatures in the ceramic substrate surface be within in several %.

Scaling-up of semiconductor substrates has been moving forward in recent years, however. For example, with silicon (Si) wafers, a transition from 8-inch to 12-inch is in progress. Consequent on this enlarging of semiconductor substrates in diametric span, that the temperature distribution in the semiconductor-substrate heating surface (retaining surface) of ceramic susceptors be within ±1.0% has become a necessity; that it be within ±0.5% has, moreover, become the expectation.

### SUMMARY OF INVENTION

The present invention has been brought about to address the foregoing issues. In particular, an object of the present invention is to make available for semiconductor manufacturing devices a wafer holder whose isothermal quality in its wafer-carrying side is heightened, and to make available a semiconductor manufacturing device in which the wafer holder is installed.

The present invention was arrived at by discovering that in the semiconductor-manufacturing-device wafer holder set out in Japanese Unexamined Pat. App. Pub. No. H04-78138, temperature distribution in the wafer-carrying side of the wafer holder becomes non-uniform because heat generated in its heater circuit is transmitted to its shaft (columnar support), and as a consequence the temperature of the wafer-carrying side directly over the shaft drops relative to the rest of the surface on that side.

Namely, in the present invention, in a wafer holder having a wafer-carrying side, the distance a between the center axis of the shaft that supports the wafer holder, and the axial center of the wafer-carrying side is 5% or less of the diameter L of the wafer-carrying side. It is desirable that the wafer holder be a ceramic susceptor having at least a resistive heating element.

In a semiconductor manufacturing device in which a wafer holder as just described is installed, the temperature of a wafer that is being processed proves to be more uniform than what has been conventional, making for better-yield manufacturing of semiconductors.

From the following detailed description in conjunction with the accompanying drawings, the foregoing and other objects, features, aspects and advantages of the present invention will become readily apparent to those skilled in the art.

### BRIEF DESCRIPTION OF DRAWINGS

The FIGURE illustrates one example of the sectional structure of a wafer holder according to the present invention.

### DETAILED DESCRIPTION

The inventors discovered that with the wafer holder in the aforementioned Pat. App. Pub. No. H04-78138, if the shaft is not attached to the center position of the wafer holder, the temperature distribution in the wafer-carrying side grows wider; and as a result of concerted investigation into the positional relationship between the shaft and the wafer-carrying side, and the temperature distribution in the wafer-carrying side, they arrived at the present invention.

In particular, the inventors found out that in order to bring the temperature distribution in the wafer-carrying side to within ±1.0% the wafer holder 1 should be made to have a distance a between the center axis of the supporting shaft 2 and the axial center of the wafer-carrying side that is 5% or less of the diameter L of the wafer-carrying side. By means of a resistive heating element formed in the wafer-holder interior or else its surface on other than the wafer-carrying side, wafers are heated by the wafer holder to undergo predetermined processes. If however the distance a between the center axis of the shaft and the axial center of the wafer-carrying side exceeds 5% of the diameter L of the wafer-carrying side, the temperature distribution in the wafer-carrying side is liable to be non-uniform. The fact that if the temperature of the wafer-carrying side drops partially, the temperature of a wafer set onto it also drops partially means that when for example carrying out a film-forming process on the wafer, the thickness and properties of the deposited film will be inconsistent. Likewise, in the case of etching processes, for example, the etching speed will fluctuate.

While the temperature distribution in the wafer-carrying side should therefore be as narrow as possible, at present temperature distributions where the isothermal rating is within ±1.0%—more desirably within ±0.5%—are being called for. The inventors discovered that in order to gain isothermal ratings of that quality, the distance a between the center axis of the shaft and the axial center of the wafer-carrying side should be 5% or less of the diameter L of the wafer-carrying side.

The temperature of a ceramic susceptor directly over the shaft joint drops in a pattern on the wafer-carrying side that is more or less the same shape as the shaft. For example, if the shaft is shaped as a round cylinder, then in a concentrically round shape an area where the temperature drops will appear. The temperature of the peripheral portion of wafer-carrying side also tends to drop, because heat radiates from the circumferential surface. The consequence for the wafer-carrying side is that the temperature of the area directly over the shaft and in the vicinity of the periphery drops, heightening the temperature adjacent the interval between the direct-over-shaft area and the periphery environs, which creates a temperature distribution in the wafer-carrying side.

Thus the more displaced are the center axis of the shaft and the axial center of the wafer-carrying side, an area will form where the longer will be the distance between the shaft and the periphery of the wafer-carrying side; the temperature differential in the wafer-carrying side in that area will be maximal. Enlargement of the temperature differential in the wafer-carrying side enlarges the temperature differential in the surface of a wafer being carried.

For these reasons, if the temperature distribution in the wafer-carrying side is to be put at an isothermal rating of within ±1.0%, the distance a between the center axis of the shaft and the axial center of the wafer-carrying side should be 5% or less of the diameter L of the wafer-carrying side. Making the distance a 1% or less of the diameter L is preferable, moreover, because it enables obtaining an isothermal rating of within ±0.5% for the temperature distribution.

Although the substantive material of a wafer holder in the present invention is not particularly limited as long as the material is an insulative ceramic, aluminum nitride (AlN), being highly thermoconductive and superlative in corrosion resistance, is preferable. In the following, a method according to the present invention of manufacturing a wafer holder in the case of AlN will be detailed.

AlN raw material powder whose specific surface area is 2.0 to 5.0 m²/g is preferable. The sinterability of the aluminum nitride declines if the specific surface area is less than 2.0 m²/g. Handling proves to be a problem if on the other hand the specific surface area is over 5.0 m²/g, because the powder coherence becomes extremely strong. Furthermore, the quantity of oxygen contained in the raw-material powder is preferably 2 wt. % or less. In sintered form, the thermal conductivity of the material deteriorates if the oxygen quantity is in excess of 2 wt. %. It is also preferable that the amount of metal impurities other than aluminum contained in the raw-material powder be 2000 ppm or less. The thermal conductivity of a sintered compact of the powder deteriorates if the amount of metal impurities exceeds this range. In particular, the content respectively of Group IV elements such as Si, and elements of the iron family, such as Fe, which as metal impurities have a serious worsening effect on the thermal conductivity of a sintered compact, is advisably 500 ppm or less.

Because AlN is not a readily sinterable material, adding a sintering promoter to the AlN raw-material powder is advisable. The sintering promoter added preferably is a rare-earth element compound. Since rare-earth element compounds during sintering react with aluminum oxides or aluminum oxynitrides present on the surface of the particles of the aluminum nitride powder, acting to promote densification of the aluminum nitride and to eliminate oxygen being a causative factor that worsens the thermal conductivity of the aluminum nitride sintered part, they enable the thermal conductivity of the aluminum nitride sintered part to be improved.

Yttrium compounds, whose oxygen-eliminating action is particularly pronounced, are preferable rare-earth element compounds. The amount added is preferably 0.01 to 5 wt. %. If less than 0.01 wt. %, producing ultrafine sintered materials is problematic, along with which the thermal conductivity of the sintered parts deteriorates. Added amounts in excess of 5 wt. % on the other hand lead to sintering promoter being present at the grain boundaries in the aluminum nitride sintered part, and consequently, if the compact is employed under a corrosive atmosphere, the sintering promoter present along the grain boundaries gets etched, becoming a source of loosened grains and particles. More preferably the amount of sintering promoter added is 1 wt. % or less. Being less than 1 wt. %, the sintering promoter will no longer be present even at the grain boundary triple points, which improves the corrosion resistance.

To characterize the rare-earth compounds further: oxides, nitrides, fluorides, and stearic oxide compounds may be employed. Among these, oxides, being inexpensive and readily obtainable, are preferable. By the same token, stearic oxide compounds are especially suitable since they have a high affinity for organic solvents, and if the aluminum nitride raw-material powder, sintering promoter, etc. are to be mixed together in an organic solvent, the fact that the sintering promoter is a stearic oxide compound will heighten the miscibility.

Next, a predetermined volume of solvent, a binder, and further, a dispersing agent or a coalescing agent as needed, are added to the aluminum nitride raw-material powder and powdered sintering promoter, and the mixture is blended together. Possible mixing techniques include ball-mill mixing and mixing by ultrasound. Mixing techniques of this sort allow a raw-material slurry to be produced.

The obtained slurry is molded, and the molded product is sintered to yield a sintered aluminum-nitride part. Co-firing and metallization are two possible methods as a way of doing this.

Metallization will be described first. Granules are prepared from the slurry by spray-drying it, or by means of a similar technique. The granules are inserted into a predetermined mold and subject to press-molding. The pressing pressure therein desirably is 0.1 t/cm² or more. With pressure less than 0.1 t/cm², sufficient strength in the molded piece cannot be produced in most cases, making the piece liable to break in handling.

Although the density of the molded piece will differ depending on the amount of binder contained and on the amount of sintering promoter added, the density is preferably 1.5 g/cm³ or more. A density of less than 1.5 g/cm³ would mean a relatively large distance between particles in the raw-material powder, which would hinder the progress of the sintering. At the same time, the molded product density preferably is 2.5 g/cm³ or less. Densities of more than 2.5 g/cm³ would make it difficult to eliminate sufficiently the binder from within the molded product in the degreasing process of the ensuing manufacturing procedure. It would consequently prove difficult to produce an ultrafine sintered part as described earlier.

Next, the molded product is heated within a non-oxidizing atmosphere to put it through a degreasing process. Carrying out the degreasing process under an oxidizing atmosphere such as air would degrade the thermal conductivity of the sinter, because the AlN powder would become superficially oxidized. For the non-oxidizing ambient gases, nitrogen and argon are preferable. The heating temperature in the degreasing process is preferably 500° C. or more and 1000° C. or less. With temperatures of less than 500° C., carbon is left remaining in excess within the molded piece following the degreasing process because the binder cannot sufficiently be eliminated, which interferes with sintering in the subsequent sintering procedure. On the other hand, at temperatures of more than 1000° C., the amount of carbon left remaining turns out to be too little, such that the ability to eliminate oxygen from the oxidized coating superficially present on the surface of the AlN powder is compromised, degrading the thermal conductivity of the sintered part.

Another condition is that the amount of carbon left remaining within the molded product after the degreasing process is preferably 1.0 wt. % or less. Since carbon remaining in excess of 1.0 wt. % interferes with sintering, an ultrafine sintered part cannot be produced.

Next, sintering is carried out. The sintering is carried out within a non-oxidizing nitrogen, argon, or like atmosphere, at a temperature of 1700 to 2000 ° C. Therein the moisture contained in the ambient gas such as nitrogen that is employed is preferably −30° C. or less given in dew point. If the atmosphere were to contain more moisture than this, the thermal conductivity of the sintered part would likely be compromised, because the AlN would react with the moisture within the ambient gas during sintering and form nitrides. Another preferable condition is that the volume of oxygen within the ambient gas be 0.001 vol. % or less. A larger volume of oxygen would lead to a likelihood that the AlN would oxidize, impairing the thermal conductivity of the sintered part.

As another condition during sintering, the jig employed is suitably a boron nitride (BN) molded part. Inasmuch as the jig as a BN molded part will be sufficiently heat resistant against the sintering temperatures, and superficially will have solid lubricity, friction between the jig and the laminate when the laminate contracts during sintering will be lessened, which will enable sinter products with little distortion to be produced.

The obtained sintered part is subjected to processing according to requirements. In cases where a conductive paste is to be screen-printed onto the sintered part in the ensuing manufacturing steps, the surface roughness is preferably 5 □m or less in Ra. If over 5 □m, in screen printing to form a circuit on the compact, defects such as blotting or pinholes in the pattern are liable to arise. More suitable is a surface roughness of 1 □m or less in Ra.

In polishing to the abovementioned surface roughness, although cases in which screen printing is done on both sides of the sintered part are a matter of course, even in cases where screen printing is effected on one side only, the polishing process should also be carried out on the surface on the side opposite the screen-printing face. This is because polishing only the screen-printing face would mean that during screen printing, the sintered part would be supported on the unpolished face, and in that situation burrs and debris would be present on the unpolished face, destabilizing the fixedness of the sintered part such that the circuit pattern might not be drawn well by the screen printing.

Furthermore, at this point the thickness uniformity (parallelism) between the processed faces is preferably 0.5 mm or less. Thickness uniformity exceeding 0.5 mm can lead to large fluctuations in the thickness of the conductive paste during screen printing. Particularly suitable is a thickness uniformity of 0.1 mm or less. Another preferable condition is that the planarity of the screen-printing face be 0.5 mm or less. If the planarity exceeds 0.5 mm, in that case too there can be large fluctuations in the thickness of the conductive paste during screen printing. Particularly suitable is a planarity of 0.1 mm or less.

Screen printing is used to spread a conductive paste and form the electrical circuits onto the sintered part having undergone the polishing process. The conductive paste can be obtained by mixing together with a metal powder an oxide powder, a binder, and a solvent according to requirements. The metal powder is preferably tungsten, molybdenum or tantalum, since their thermal expansion coefficients match those of ceramics.

Adding the oxide powder to the conductive paste is also to enhance the strength with which it bonds to AlN. The oxide powder preferably is an oxide of Group IIa or Group IIIa elements, or is Al₂O₃, SiO₂, or a like oxide. Yttrium oxide is especially preferable because it has very good wettability with AlN. The amount of such oxides added is preferably 0.1 to 30 wt. %. If the amount is less than 0.1 wt. %, the bonding strength between AlN and the metal layer being the circuit that has been formed is compromised. On the other hand, amounts in excess of 30 wt. % make the electrical resistance of the circuit metal layer high.

The thickness of the conductive paste is preferably 5 □m or more and 100 □m or less in terms of its post-drying thickness. If the thickness is less than 5 □m the electrical resistance would be too high and the bonding strength would decline. Likewise, if in excess of 100 □m the bonding strength would be compromised in that case as well.

Also preferable is that in the patterns for the circuits that are formed, in the case of the heater circuit (resistive heating element circuit), the pattern spacing be 0.1 mm or more. With a spacing of less than 0.1 mm, shorting will occur when current flows in the resistive heating element and, depending on the applied voltage and the temperature, leakage current is generated. Particularly in cases where the circuit is employed at temperatures of 500° C. or more, the pattern spacing preferably should be 1 mm or more; more preferable still is that it be 3 mm or more.

After the conductive paste is degreased, baking follows. Degreasing is carried out within a non-oxidizing nitrogen, argon, or like atmosphere. The degreasing temperature is preferably 500° C. or more. At less than 500° C., elimination of the binder from the conductive paste is inadequate, leaving behind carbon in the metal layer that when baked will form metal carbides and consequently raise the electrical resistance of the metal layer.

The baking is suitably done within a non-oxidizing nitrogen, argon, or like atmosphere at a temperature of 1500° C. or more. At temperatures of less than 1500° C., the post-baking electrical resistance of the metal layer turns out too high because the baking of the metal powder within the paste does not proceed to the grain growth stage. A further baking parameter is that the baking temperature should not surpass the sintering temperature of the ceramic produced. If the conductive paste is baked at a temperature beyond the sintering temperature of the ceramic, dispersive volatilization of the sintering promoter incorporated within the ceramic sets in, and moreover, grain growth in the metal powder within the conductive paste is accelerated, impairing the bonding strength between the ceramic and the metal layer.

Next, in order to ensure that the formed metal layer is electrically isolated, an insulative coating can be formed on the metal layer. Preferably the insulative coating substance is the same substance as the ceramic on which the metal layer is formed. Problems such as post-sintering warpage arising from the difference in thermal expansion coefficients will occur if the ceramic and insulative coating substances differ significantly. For example, in a case where the ceramic is AlN, a predetermined amount of an oxide/carbide of a Group IIa element or a Group IIIa element can be added to and mixed together with AlN powder, a binder and a solvent added and the mixture rendered into a paste, and the paste can be screen-printed to spread it onto the metal layer.

In that case, the amount of sintering promoter added preferably is 0.01 wt. % or more. With an amount less than 0.01 wt. % the insulative coating does not densify, making it difficult to secure electrical isolation of the metal layer. It is further preferable that the amount of sintering promoter not exceed 20 wt. %. Surpassing 20 wt. % leads to excess sintering promoter invading the metal layer, which can end up altering the metal-layer electrical resistance. Although not particularly limited, the spreading thickness preferably is 5 □m or more. This is because securing electrical isolation proves to be problematic at less than 5 □m.

Next, in the present method, the ceramic as substrates furthermore can be laminated according to requirements. Lamination may be done via a bonding agent. The bonding agent—being a compound of Group IIa or Group IIIa elements, and a binder and solvent, added to an aluminum oxide powder or aluminum nitride powder and made into a paste—is spread onto the bonding surface by a technique such as screen printing. The thickness of the applied bonding agent is not particularly restricted, but preferably is 5 □m or more. Bonding defects such as pin-holes and bonding irregularities are liable to arise in the bonding layer with thicknesses of less than 5 □m.

The ceramic substrates onto which the bonding agent has been spread are degreased within a non-oxidizing atmosphere at a temperature of 500° C. or more. The ceramic substrates are thereafter bonded to one another by stacking together the ceramic substrates to be laminated, applying a predetermined load to the stack, and heating it within a non-oxidizing atmosphere. The load preferably is 0.05 kg/cm² or more. With loads of less than 0.05 kg/cm² sufficient bonding strength will not be obtained, and otherwise the bonding defects just note will be prone to occur.

Although the heating temperature for bonding is not particularly restricted as long as it is a temperature at which the ceramic substrates adequately bond to one another via the bonding layers, preferably it is 1500° C. or more. With adequate bonding strength proving difficult to gain at less than 1500° C., defects in the bond are liable to arise. Nitrogen or argon is preferably employed for the non-oxidizing atmosphere during the degreasing and boding just discussed.

A ceramic sinter laminate that serves as a wafer holder thus can be produced as in the foregoing. As far as the electrical circuits are concerned, it should be understood that if they are heater circuits for example, then a molybdenum coil can be utilized, and in cases electrostatic-chuck electrode and RF electrode cases, molybdenum or tungsten mesh can be, without employing conductive paste.

In such cases, the molybdenum coil or the mesh can be built into the AlN raw-material powder, and the wafer holder can be fabricated by hot pressing. While the temperature and atmosphere in the hot press may be on par with the AlN sintering temperature and atmosphere, the hot press desirably applies a pressure of 10 kg/cm² or more. With pressure of less than 10 kg/cm², the wafer holder might not demonstrate its performance capabilities, because interstices arise between the AlN and the molybdenum coil or the mesh.

Co-firing will now be described. The earlier-described raw-material slurry is molded into sheets by doctor blading. The sheet-molding parameters are not particularly limited, but the post-drying thickness of the sheets advisably is 3 mm or less. The sheet thickness surpassing 3 mm leads to large shrinkage in the drying slurry, raising the probability that fissures will be generated in the sheet.

A metal layer of predetermined form that serves as an electrical circuit is formed onto an abovementioned sheet using a technique such as screen printing to spread onto it a conductive paste. The conductive paste utilized can be the same as that which was descried under the metallization method. Nevertheless, not adding an oxide powder to the conductive paste does not hinder the co-firing method.

Subsequently, the sheet that has undergone circuit formation is laminated with sheets that have not. Lamination is by setting the sheets each into predetermined position to stack them together. Therein, according to requirements, a solvent is spread on between sheets. In the stacked state, the sheets are heated as may be necessary. In cases where the stack is heated, the heating temperature is preferably 150° C. or less. Heating to temperatures in excess of this greatly deforms the laminated sheets. Pressure is then applied to the stacked-together sheets to unitize them. The applied pressure is preferably within a range of from 1 to 100 MPa. At pressures less than 1 MPa, the sheets are not adequately unitized and can peel apart during subsequent manufacturing steps. Likewise, if pressure in excess of 100 MPa is applied, the extent to which the sheets deform becomes too great.

This laminate undergoes a degreasing process as well as sintering, in the same way as with the metallization method described earlier. Parameters such as the temperature in degreasing and sintering and the amount of carbon are the same as with metallization. A wafer holder having a plurality of electrical circuits can be readily fabricated by printing, in the previously described screen printing of a conductive paste onto sheets, heater circuits, electrostatic-chuck electrodes, etc. respectively onto a plurality of sheets and laminating them. In this way a ceramic sinter laminate that serves as a wafer holder can be produced.

The obtained ceramic sinter laminate is subject to processing according to requirements. As a rule, in the sintered state the ceramic sinter laminate usually is not within the precision demanded in semiconductor manufacturing devices. The planarity of the wafer-carrying side as an example of processing precision is preferably 0.5 mm or less; moreover 0.1 mm or less is particularly preferable. The planarity surpassing 0.5 mm is apt to give rise to interstices between the wafer holder and a wafer the holder carries, keeping the heat of the wafer holder from being uniformly transmitted to the wafer and making the generation of temperature irregularities in the wafer likely.

A further preferable condition is that the surface roughness of the wafer-carrying side be 5 □m in Ra. If the roughness is over 5 □m in Ra, grains loosened from the AlN due to friction between the wafer holder and the wafer can grow numerous. Grain-loosened particles in that case become contaminants that have a negative effect on processes, such as film deposition and etching, on the wafer. Furthermore, then, a surface roughness of 1 □m or less in Ra is ideal.

A wafer holder base part can thus be fabricated as in the foregoing. A shaft is then attached to the wafer holder. Although the shaft substance is not particularly limited as long as its thermal expansion coefficient is not appreciably different from that of the wafer-holder ceramic, the difference in thermal expansion coefficient between the shaft substance and the wafer holder preferably is 5×10⁻⁶ K or less.

If the difference in thermal expansion coefficient exceeds 5×10⁻⁶ K, cracks can arise adjacent the joint between the wafer holder and the shaft when it is being attached; but even if cracks do not arise when the two are joined, splitting and cracking can occur in the joint in that it is put through heating cycling in the course of being repeatedly used. For cases in which the wafer holder is AlN, for example, the shaft substance is optimally AlN; but silicon nitride, silicon carbide, or mullite can be used.

Mounting is joining via an adhesive layer. The adhesive layer constituents preferably are composed of AlN and Al ₂O₃, as well as rare-earth oxides. These constituents are preferable because of their favorable wettability with the AlN or like ceramic that is the substance of the wafer holder and the shaft, which makes the joint strength relatively high, and readily produces a gastight joint surface.

The planarity of the respective joining faces of the shaft and wafer holder to be joined preferably is 0.5 mm or less. Beyond this level interstices are liable to occur in the joining faces, impeding the production of a joint having adequate gastightness. A planarity of 0.1 mm or less is more suitable. Here, still more suitable is a planarity of the wafer holder joining faces of 0.02 mm or less. Likewise, the surface roughness of the respective joining faces preferably is 5 □m or less in Ra. Surface roughness exceeding this would then also mean that interstices are liable to occur in the joining faces. A surface roughness of 1 □m or less in Ra is still more suitable.

Subsequently, electrodes are attached to the wafer holder. The attaching can be done according to publicly known techniques. For example, the side of the wafer holder opposite its wafer-carrying side may be spot faced through to the electrical circuit, and metallization to the circuit carried out, or without metallizing, electrodes of molybdenum, tungsten, etc. may be connected to the circuit directly using activated metal brazing material. The electrodes can thereafter be plated as needed to improve their resistance to oxidation. In this way, a wafer holder for semiconductor manufacturing devices can be fabricated.

Moreover, semiconductor wafers can be processed on a wafer holder according to the present invention, integrated into a semiconductor manufacturing device. Inasmuch as the temperature of the wafer-carrying side of a wafer holder by the present invention is uniform, the temperature distribution in the wafer will be more uniform than is conventional, to yield stabilized characteristics in terms of deposited films, heating processes, etc.

Embodiments

Embodiment 1-99 parts by weight aluminum nitride powder and 1 part by weight Y₂ O₃ powder were mixed and blended with 10 parts by weight polyvinyl butyral as a binder and 5 parts by weight dibutyl phthalate as a solvent, and doctor-bladed into green sheets 430 mm in diameter and 1.0 mm in thickness. Here, an aluminum nitride powder having a mean particle diameter of 0.6 □m and a specific surface area of 3.4 m²/g was utilized. In addition, a tungsten paste was prepared with a tungsten powder of 2.0 □m mean particle diameter being 100 parts by weight, utilizing Y₂O₃ at 1 part by weight, 5 parts by weight ethyl cellulose, being a binder, and as a solvent, butyl Carbitol™. A pot mill and a triple-roller mill were used for mixing. This tungsten paste was formed into a heater circuit pattern on the green sheets by screen-printing.

Pluralities of separate green sheets of 1.0 mm thickness were laminated onto the green sheets printed with the heater circuit to create laminates. Lamination was carried out by stacking the sheets in place in a mold, and thermopressing 2 minutes in a press at a pressure of 10 MPa while maintaining 50° C. heat. The laminates were there-after degreased within a nitrogen atmosphere at 600° C., and sintered within a nitrogen atmosphere under time and temperature conditions of 3 hours and 1800° C., whereby wafer holders were fabricated. Here, a polishing process was performed on the wafer-carrying side so that it would be 1 □m or less in Ra, and on the shaft-joining face so that it would be 5 □m or less in Ra. The wafer holders were also processed to true their outer diameter. The dimensions of the post-processing wafer holders were 340 mm outer diameter (L) and 20 mm thickness.

Next a shaft made of AlN, 80 mm outside diameter, 60 mm inside diameter, and 300 mm length was attached to the surface on the side opposite the wafer-carrying side. The bonding agent was 50% Al₂O₃-30%Y₂O₃-20% AlN. The attachment locations were where the distance a between the center axis of the shaft and the axial center of the wafer-carrying side was as set forth in the table.

The heater circuits in the wafer holders were partially exposed by spot-facing in two places through the surface on the side opposite the wafer-carrying side, as far as the heater circuit. Electrodes made of tungsten were connected directly to the exposed portions of the heater circuits utilizing an active metal brazing material. The wafer holders were heated by passing current through the electrodes, and their isothermal ratings were measured. Assaying isothermal quality was by placing a 12-inch wafer temperature gauge on the wafer-carrying side and measuring its temperature distribution. It is to be noted that the supplied electric power was adjusted so that the temperature in the midportion of the wafer temperature gauge would be 550° C. The results are set forth in the table.

TABLE

| No. | a(mm) | a/L(%) | Isothermal rating(%) |
|---|---|---|---|
| 1 | 0 | 0.0 | ±0.35 |
| 2 | 1 | 0.2 | ±0.34 |
| 3 | 3 | 0.9 | ±0.43 |
| 4 | 5 | 1.4 | ±0.52 |
| 5 | 10 | 2.9 | ±0.66 |
| 6 | 15 | 4.4 | ±0.78 |
| 7 | 20 | 5.8 | ±1.03 |
| 8 | 25 | 7.3 | ±1.55 |
| 9 | 30 | 8.8 | ±2.69 |
| 10 | 40 | 11.7 | ±4.35 |

As is evident from the table, having the distance a between the center axis of the shaft and the axial center of wafer-carrying side be 5% or less of the diameter L of wafer-carrying side enables the temperature distribution in the wafer-carrying side to be brought within ±0%. What is more, rendering the distance a 1% or less of the diameter L makes it possible to bring the temperature distribution in the wafer-carrying side to within ±5%.

Embodiment 2—The wafer holders of the table were assembled into a semiconductor manufacturing device, wherein TiN films were formed onto silicon wafers 12 inches in diameter. In cases in which wafer holders Nos. 7 through 10 were used, fluctuations in the TiN film thickness were a large 15% or more; but in cases in which the wafer holders other than these were utilized, being that fluctuations in the film thickness were a small 10% or less, excellent TiN films could be formed.

According to the present invention as given in the foregoing, having the distance a between the center axis of the shaft and the axial center of the wafer-carrying side be 5% or less of the diameter L of the wafer-carrying side affords wafer holders and semiconductor manufacturing devices excelling in isothermal quality.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. For a semiconductor manufacturing device, a wafer holder comprising:
a substrate having a wafer-carrying side; and
a substrate-supporting shaft joined to said substrate such that a distance a between the center axis of said shaft and the axial center of said wafer-carrying side of said substrate is 5% or less of the diameter L of the wafer-carrying side.

2. A wafer holder as set forth in claim 1, being a ceramic susceptor including at least a resistive heating element.

3. A semiconductor manufacturing device in which a wafer holder as set forth in claim 1 is installed.

4. A semiconductor manufacturing device in which a wafer holder as set forth in claim 2 is installed.
